(19) United States
(12) Patent Application Publication
(10) Pub. No.: US 2016/0281337 A1
(43) Pub. Date: Sep. 29, 2016

(54) PROPORTIONAL PRESSURE REDUCING VALVE FOR WATERWORKS

(71) Applicant: KANE KOUGYOU CO., LTD., Komaki-shi (JP)

(72) Inventors: Masaru OCHIAI, Komaki-shi (JP); Nobuyuki MATSUURA, Komaki-shi (JP)

(21) Appl. No.: 15/060,730

(22) Filed: Mar. 4, 2016

(30) Foreign Application Priority Data
Mar. 24, 2015 (JP) 2015-60513

(51) Int. Cl. E03B 7/07; F16K 17/02; G05D 16/10; F16K 17/22; F16K 47/04; F16K 31/122

(52) U.S. Cl. CPC E03B 7/07; F16K 47/04; F16K 31/122; G05D 16/10; F16K 17/22; F16K 17/02

(57) ABSTRACT

A proportional pressure reducing valve for waterworks structured so as to prevent water leakage to the exterior of a valve box even if water leakage occurs into an airtight chamber by some chance.

### TECHNICAL FIELD

The present invention relates to a proportional pressure reducing valve for use in waterworks for which a secondary pressure is kept at a predetermined ratio with respect to a primary pressure.

### BACKGROUND ART

This type of proportional pressure reducing valve is proposed in Patent Document 1.

For this pressure reducing valve, a cylindrical valve box having an inlet opened in a front end surface thereof and an outlet set to be larger in diameter than the inlet and opened in a rear end surface thereof is provided, a reduced diameter portion in an annular projection shape is formed so as to bulge out on an inner wall between the inlet and the outlet of the valve box, through the reduced diameter portion, a piston provided at its distal end with a valve portion that opens and closes the inlet and provided with a hollow portion opening at a base end side thereof to the outlet and having a plurality of water-flow ports in communication with the hollow portion opened in a distal end-side peripheral surface thereof located at all times further to the front than the reduced diameter portion is inserted in an airtight state brought about by a packing and freely slidably, and a flange that slides in an airtight state brought about by a packing a valve box inner wall that is further to the rear than the reduced diameter portion is provided around the base end of the piston.

Moreover, an airtight chamber provided between the flange and the reduced diameter portion is in communication with the exterior by a vent path that penetrates through a valve box sidewall, and air enters and exits the interior of the airtight chamber that expands and contracts according to advancement or retraction of the piston that operates during valve opening or closing of the valve portion to thereby allow the piston to operate without difficulty.

### PRIOR ART DOCUMENT

### Patent Document

[Patent Document 1] Japanese Patent No. 3725501

### SUMMARY OF THE INVENTION

### Problem(s) to be Solved by the Invention

However, in the pressure reducing valve configured as described above, there is a problem that, if the packing of the reduced diameter portion or the flange deteriorates due to use over time, water inside a flow path in the valve box leaks from the airtight chamber to the outside through the vent path, and a large amount of water leaks until repair or replacement of the pressure reducing valve.

Therefore, it is an object of the present invention to provide a proportional pressure reducing valve for waterworks structured so as to prevent water leakage to the exterior of a valve box even if water leakage occurs into an airtight chamber by some chance.

### Means for Solving the Problem(s)

In view of the above-described problem, a proportional pressure reducing valve for waterworks according to the present invention is constructed by providing a cylindrical valve box having an inlet opened in a front end surface thereof and an outlet set to be larger in diameter than the inlet and opened in a rear end surface thereof, forming a reduced diameter portion in an annular projection shape so as to bulge out on an inner wall between the inlet and the outlet of the valve box, inserting through the reduced diameter portion in an airtight state and freely slidably a piston provided at its distal end with a valve portion that opens and closes the inlet and provided with a hollow portion opening at a base end side thereof to the outlet and having a plurality of water-flow ports in communication with the hollow portion opened in a distal end-side peripheral surface thereof located at all times further to the front than the reduced diameter portion, and providing a flange that slides in an airtight state a valve box inner wall that is further to the rear than the reduced diameter portion around the base end of the piston, and an airtight chamber provided between the flange and the reduced diameter portion is in communication with a hollow chamber defined by airtightly blocking a recess portion for which the periphery of a valve box outer wall is formed to cave in by a cylindrical cover externally fitted to the valve box.

Also, the airtight chamber and the hollow chamber are in communication with each other via a diaphragm, and specifically, an annular flow path in communication with the airtight chamber and an annular flow path in communication with the hollow chamber are provided concentrically with the valve box and in a separated manner at the front and rear inside a valve box sidewall, and both annular flow paths are brought into communication with each other by a diaphragm formed by a helical groove provided inside the valve box sidewall so as to circle around a valve box axial center.

Further, the cylindrical cover is made transparent, an opening portion in external communication with the hollow chamber is provided in an appropriate part of the cylindrical cover, and the opening portion is airtightly blocked by a sealing plug.

Alternatively, a stop cock is coupled to the cylindrical cover via a transparent pipe that is in communication with the hollow chamber.

Also, a large number of replaceable lid bodies are freely removably provided in an opening portion provided in the front end surface of the valve box, and inlets having different bores are formed in each of the lid bodies.

### Effects of the Invention

In brief, the present invention provides a proportional pressure reducing valve for waterworks constructed by providing a cylindrical valve box having an inlet opened in a front end surface thereof and an outlet set to be larger in diameter than the inlet and opened in a rear end surface thereof, forming a reduced diameter portion in an annular projection shape so as to bulge out on an inner wall between the inlet and the outlet of the valve box, inserting through the reduced diameter portion in an airtight state and freely slidably a piston provided at its distal end with a valve portion that opens and closes the inlet and provided with a hollow portion opening at a base end side thereof to the outlet and having a plurality of water-flow ports in communication with the hollow portion opened in a distal end-side peripheral surface thereof located at all times further to the front than the reduced diameter portion, and providing a flange that slides in an airtight state a valve box inner wall that is further to the rear than the reduced diameter portion around the base end of the piston, in which an airtight chamber provided between the flange and the reduced diameter portion is in communication with a hollow chamber defined by airtightly blocking a recess portion for which the periphery of a valve box outer wall is formed to cave in by a cylindrical cover externally fitted to the valve box, and theretofore, even when the reduced diameter portion through which the piston slides or the flange that slides the valve box inner wall is reduced in airtightness due to use over time and even if water leakage occurs from the inside of a flow path in the valve box into the airtight chamber by some chance, the leaked water in the airtight chamber flows into the hollow chamber, but because the hollow chamber is airtightly blocked by the cylindrical cover, water leakage to the exterior of the valve box can be prevented, and the inconvenience that a large amount of water leaks until repair or replacement of the pressure reducing valve can be avoided.

Also, the airtight chamber and the hollow chamber are in communication with each other via a diaphragm, and specifically, an annular flow path in communication with the airtight chamber and an annular flow path in communication with the hollow chamber are provided concentrically with the valve box and in a separated manner at the front and rear inside a valve box sidewall, and both annular flow paths are brought into communication with each other by a diaphragm formed by a helical groove provided inside the valve box sidewall so as to circle around a valve box axial center, and therefore, because air that enters or exits, from or into the hollow chamber, the airtight chamber that expands and contracts according to advancement or retraction of the piston that operates during valve opening or closing of the valve portion passes through the diaphragm, the piston can be allowed to decelerate until reaching its moving end, and particularly during the valve closing, the occurrence of water hammer can be prevented because the valve portion gradually closes the inlet.

Because the cylindrical cover is made transparent, the interior of the hollow chamber can be visually checked from the exterior of the valve box through the cylindrical cover, and even if there is by some chance a water leakage into the airtight chamber through the airtight chamber from a flow path in the valve box, the status thereof can be checked from the outside.

Also, because an opening portion in external communication with the hollow chamber is provided in an appropriate part of the cylindrical cover and the opening portion is airtightly blocked by a sealing plug, the sealing plug is opened when a water leakage into the hollow chamber is confirmed, the water in the hollow chamber is discharged to check the status as to if the water leakage is temporary and the like, which can then be used for the subsequent processing, operation, and the like.

Because a stop cock is coupled to the cylindrical cover via a transparent pipe that is in communication with the hollow chamber, even if there is by some chance a water leakage into the hollow chamber through the airtight chamber from a flow path in the valve box, the status thereof can be checked from the exterior of the transparent pipe that is in communication with the hollow chamber, and when a water leakage into the hollow chamber is confirmed, the water in the hollow chamber is discharged by opening the sealing plug to check the status as to if the water leakage is temporary and the like, which can then be used for the subsequent processing, operation, and the like.

Moreover, in the proportional pressure reducing valve according to the present invention, the secondary pressure can be set by changing the bore (area) of the inlet, which therefore provides enormous practical effects such that freely removably providing a large number of replaceable lid bodies in an opening portion provided in the front end surface of the valve box and forming inlets having different bores in each of the lid bodies allows simply setting a desired secondary pressure by only fitting a lid body with an inlet having an appropriate bore to the opening portion.

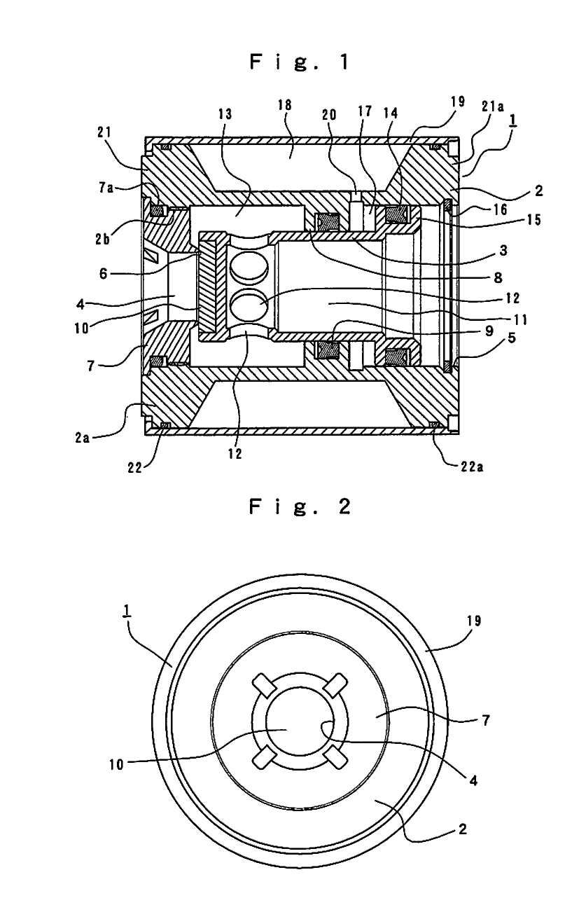

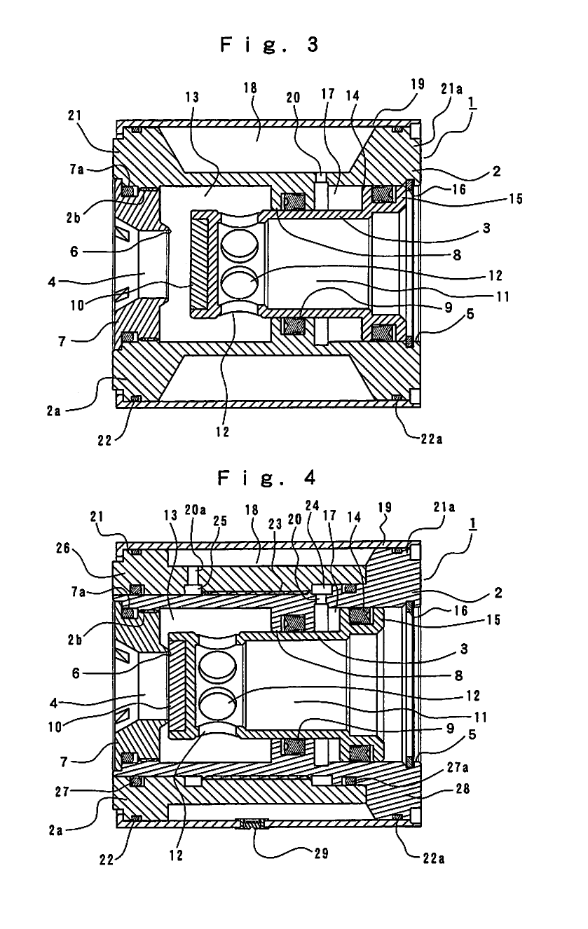

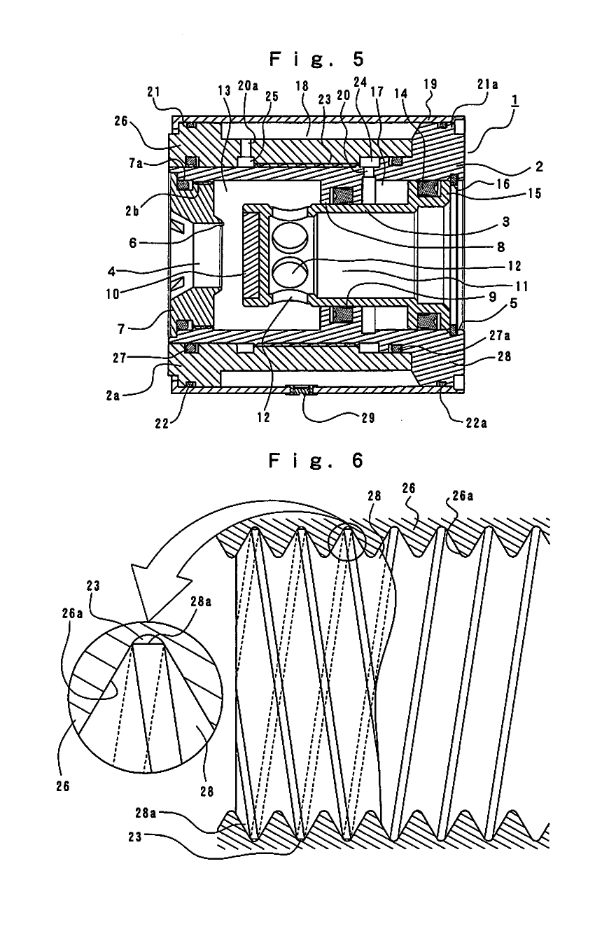

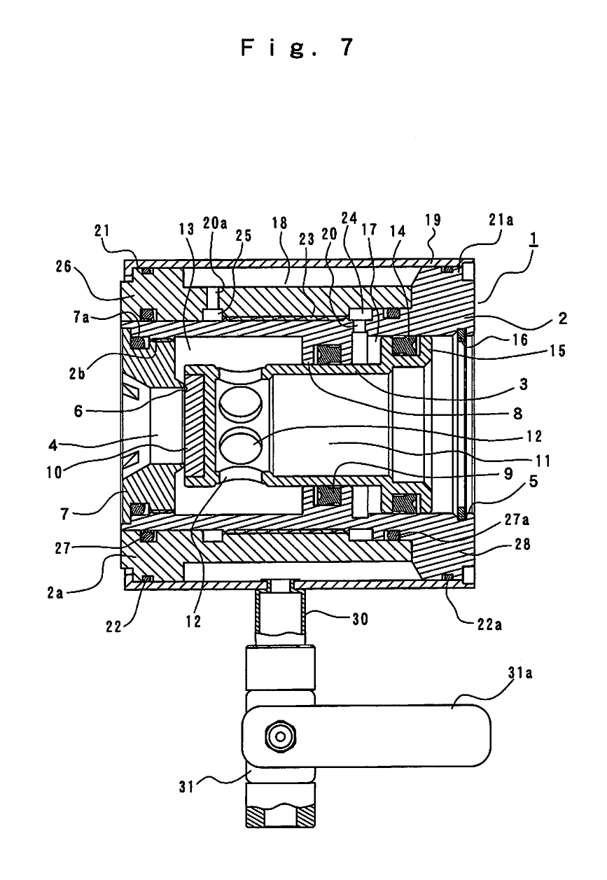

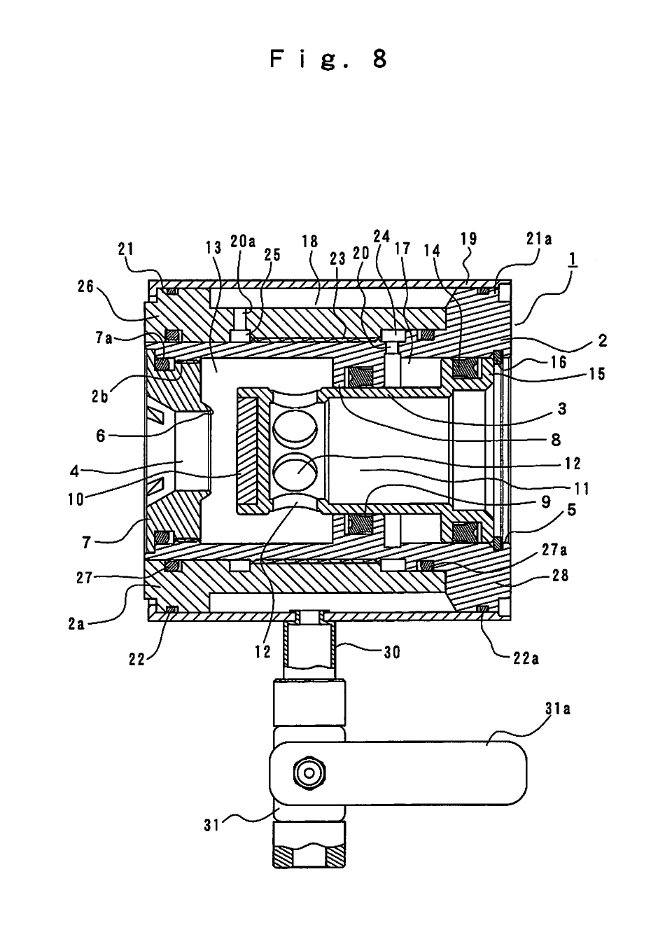

### BRIEF DESCRIPTION OF THE DRAWINGS

[FIG. 1] A sectional view showing a closed state of a proportional pressure reducing valve for waterworks.

[FIG. 2] A front view of the same as the above.

[FIG. 3] A sectional view showing an open state of the same as the above.

[FIG. 4] A sectional view showing a closed state of a second embodiment.

[FIG. 5] A sectional view showing an open state of the same as the above.

[FIG. 6] A simplified explanatory schematic view showing a diaphragm.

[FIG. 7] A sectional view showing a closed state of a third embodiment.

[FIG. 8] A sectional view showing an open state of the same as the above.

### MODES FOR CARRYING OUT THE INVENTION

Hereinafter, a mode for carrying out the present invention will be described based on the drawings.

Reference symbol 1 denotes an in-line type proportional pressure reducing valve for waterworks, which is composed mainly of its valve box 2 and a piston 3 fitted inside the valve box 2, and is disposed by interposing the valve box 2 between pipe flanges for use in waterworks (not shown) and fastening the pipe flanges together by bolts and nuts.

The valve box 2 is formed in a cylindrical shape a sidewall 2a of which is thick-walled, has an inlet 4 opened in a front end surface thereof and an outlet 5 set to be larger in diameter than the inlet 4 and opened in a rear end surface thereof, to be formed with a straight flow path of the inlet 4 and the outlet 5, and has a valve seat 6 provided in a projecting manner at the rim of a secondary-side opening portion of the inlet 4.

In addition, the inlet 4 is provided by boring in the center of a lid body 7 freely removably provided in a watertight state by an O-ring 7a in an opening portion 2b provided in the center of the front end surface of the valve box 2.

As this lid body 7, a large number of lid bodies are provided so as to be replaceable such that, by forming inlets 4 having different bores in each of the respective lid bodies 7 and fitting a lid body 7 with an inlet 4 having an appropriate bore to the opening portion 2b, a desired secondary pressure is set.

At an inner wall in a substantially middle part between the inlet 4 and the outlet 5 in the valve box 2, a reduced diameter portion 8 in an annular projection shape is formed so as to bulge out, and through the reduced diameter portion 8, the piston 3 is inserted in an airtight state brought about by a U-packing 9 and freely slidably.

The piston 3 is provided at its distal end with a valve portion 10 that opens and closes the inlet 4 by seating itself or leaving the valve seat 6, and is formed in a cylindrical shape provided with a hollow portion 11 opening at a base end side thereof to the outlet 5.

In the piston 3, at a distal end-side peripheral surface located at all times further to the front than the reduced diameter portion 8, a plurality of water-flow ports 12 in communication with the hollow portion 11 are opened.

Moreover, at the distal end-side peripheral surface of the piston 3, a gap 13 with an inner wall of the valve box 2 that communicates with the inlet 4 when the valve is opened to become a part of a pressure fluid flow path, and the gap 13 has a sectional area (corresponding to the area of a ring form between the valve box 2 and the piston 3) set larger than the area of the inlet 4.

At the base end (opening end) of the piston 3, a flange 15 that slides in an airtight state brought about by a U-packing 14 an inner wall of the valve box 2 that is further to the rear than the reduced diameter portion 8 is provided therearound.

At an inner periphery of the outlet 5 of the valve box 2, a retaining ring 16 to retain the piston 3 (flange 15) is provided in a projecting manner, and the piston 3 has its stroke (moving) ends at the valve seat 6 on which the valve portion 10 is seated and the retaining ring 16 with which the flange 15 contacts by collision.

Inside of the valve box 2, between the flange 15 and the reduced diameter portion 8, an airtight chamber 17 is provided which expands and contracts in capacity according to advancement or retraction of the piston 3.

The airtight chamber 17 is in communication with a hollow chamber 18 defined by airtightly blocking a recess portion 18 for which the periphery of an outer wall of the valve box 2 is formed to cave in by a cylindrical cover 19 externally fitted to the valve box 2.

In addition, the hollow chamber 18 is of course formed larger in capacity than the airtight chamber 17, which allows advancing and retracting operations of the piston 3 without difficulty.

In addition, the airtight chamber 17 and the hollow chamber 18 are in communication with each other via one vent path 20 bored in the valve box sidewall 2a as a partition therebetween as to inside and outside, and the airtightness of the hollow chamber 18 is kept by an inner surface of front and rear end portions of the cylindrical cover 19 being sealed by O-rings 22 and 22a provided around flange portions 21 and 21a formed in each of the front and rear end portions of the valve box 2 by the formation of the recess portion 18.

Next, a second embodiment will be described based on FIGS. 4 to 6. In addition, the present embodiment is a modification mainly in the valve box 2 and the cylindrical cover 19, and is the same in other aspects of the configuration as the above, and therefore, the same or corresponding parts as the above are denoted by the same reference symbols in the figures, so as to omit their description.

In the present proportional pressure reducing valve 1, the airtight chamber 17 and the hollow chamber 18 are brought into communication with each other via a diaphragm 23.

Specifically, an annular flow path 24 in communication with the airtight chamber 17 and an annular flow path 25 in communication with the hollow chamber 18 are provided concentrically with the valve box 2 and in a separated manner at the front and rear inside the valve box sidewall 2a, and both annular flow paths 24 and 25 are brought into communication with each other by the diaphragm 23 formed by a helical groove provided inside the valve box sidewall 2a so as to circle around an axial center of the valve box 2.

The valve box 2 is made up of an outer ring 26 having a front flange portion 21 and a recess portion 18 and an inner ring 28 that integrates the same by screw fitting in an airtight state brought about by O-rings 27 and 27a to be made into a valve box sidewall 2a, and the root of a rear flange portion 21a projecting on a rear end portion of the inner ring 28 stops a rear end portion of the outer ring 26 by contact.

As shown in a simplified manner in FIG. 6, a male screw 28a of the inner ring 28 is cut away at its thread top portion to be flat, so that the helical groove (diaphragm) 23 is constructed when the male screw 28a is screwed with a female screw 26a of the outer ring 26.

At each of the front and rear ends of the female screw 26a in the outer ring 26 and the front end rear ends of the male screw 26b in the inner ring 28, cut-away grooves in predetermined shapes are continuously formed, and these are constructed similarly to the helical groove 23 as the annular flow paths 24 and 25 that continue from the front and rear ends thereof when the outer ring 26 and the inner ring 28 are screwed with each other.

The inner ring 28 is provided by boring with one vent path 20 that communicates with the airtight chamber 17 constructed inside of the same and the annular flow path 24 constructed between the inner and outer rings 26 and 28, and the outer ring 26 is provided by boring with one vent path 20a that communicates with the hollow chamber 18 constructed outside of the same and the annular flow path 25 constructed between the inner and outer rings 26 and 28.

Moreover, more preferably, the cylindrical cover 19 is formed of transparent reinforced plastic that desirably allows visually checking the interior of the hollow chamber 18.

In this case, an opening portion in external communication with the hollow chamber 18 is provided in an appropriate part (in the illustrated example, a lower portion) of the cylindrical cover 19, and the opening portion is airtightly blocked by a sealing plug 29.

In addition, when the cylindrical cover 19 is not transparent, as in a third embodiment shown in FIGS. 7 and 8, a ball stop cock 31 may be coupled to an appropriate part (in the illustrated example, a lower portion) of the cylindrical cover 19 via a transparent pipe 30 that is in communication with the hollow chamber 18.

In addition, reference symbol 31a shown in the figures denotes a handle that manually opens and closes a valve element (not shown) of the ball stop cock 31.

The proportional pressure reducing valve 1 of the third embodiment shown in FIGS. 7 and 8 is the same in configuration as the second embodiment except the point that the cylindrical cover 19 is not transparent and the point that the transparent pipe 30 and the ball stop cock 31 are coupled to the cylindrical cover 19, and therefore, the same or corresponding parts as the above are denoted by the same reference symbols in the figures, so as to omit their description.

In addition, also for the proportional pressure reducing valve 1 of the first embodiment shown in FIGS. 1 and 2, the cylindrical cover 19 may be made transparent, an opening portion in external communication with the hollow chamber 18 may be provided in an appropriate part of the cylindrical cover 19, and the opening portion may be airtightly blocked by a sealing plug 29, or a ball stop cock 31 may be coupled to an appropriate part of the cylindrical cover 19 via a transparent pipe 30 that is in communication with the hollow chamber 18.

In the proportional pressure reducing valve 1 having the above-described configuration, there is a configuration so that an acting force in a primary-side direction that acts on the valve portion 10 of the piston 3 can balance with a fluid acting force (a product of the area to receive a secondary pressure on the side of the hollow portion 11 (corresponding to the area of the outlet 5) and the secondary pressure) in a secondary-side direction that acts on the side of the hollow portion 11 of the piston 3 by use of a bore difference between the inlet 4 and the outlet 5, and the secondary pressure can be set by changing the area (bore) of the inlet 4.

Therefore, when the secondary pressure is a predetermined pressure, the proportional pressure reducing valve 1 is in a closed state with the valve portion 10 seated on the valve seat 6, and when the secondary pressure falls from the predetermined pressure by opening a hydrant cock and using water, the valve portion 10 separates from the valve seat 6 due to a primary pressure to open the valve, and a primary-side fluid flows into the secondary side through the inlet 4, the gap 13, the water-flow ports 12, and the hollow portion 11.

When the hydrant cock is closed after using water, the piston 3 is pushed back to the primary side with a rise in the secondary pressure, and closes the valve at a point in time when the secondary pressure has reached a predetermined pressure.

When the piston 3 performs an advancing/retracting operation during valve opening or closing of the valve portion 10, the airtight chamber 17 is caused to expand and contract in capacity, but because the hollow chamber 18 in communication with the airtight chamber 17 is formed larger in capacity than the airtight chamber 17 so as to allow the amount of air that enters or exits the airtight chamber 17 from or into the hollow chamber 18, the piston 3 can perform the advancing/retracting operation without difficulty even when the hollow chamber 18 is airtightly blocked by the cylindrical cover 19 and is thus not in communication with the exterior of the valve box 2.

Moreover, even when the U-packing 9, 14 of the reduced diameter portion 8 through which the piston 3 slides or the flange 15 that slides the inner wall of the valve box 2 deteriorates to be reduced in its airtightness due to use of the proportional pressure reducing valve 1 over time and even if water leakage occurs from the inside of a flow path in the valve box 2 into the airtight chamber 17 by some chance, the leaked water in the airtight chamber 17 flows into the hollow chamber 18 through the vent path 20 in the case of the proportional pressure reducing valve 1 of the first embodiment, and in the case of the proportional pressure reducing valve 1 of the second or third embodiment, the leaked water flows into the hollow chamber 18 through the vent path 20, the annular flow path 24, the diaphragm 23, the annular flow path 25, and the vent path 20a, but the hollow chamber 18 is airtightly blocked by the cylindrical cover 19, water leakage to the exterior of the valve box 2 is prevented.

Also, in the proportional pressure reducing valve 1 of the second or third embodiment where the airtight chamber 17 and the hollow chamber 18 are in communication with each other via the long and narrow diaphragm (helical groove) 23, because air that enters or exits, from or into the hollow chamber 18, the airtight chamber 17 that expands and contracts according to advancement or retraction of the piston 3 that operates during normal valve opening or closing of the valve portion 10 passes through the diaphragm 23, the piston 3 can be allowed to decelerate until reaching its moving end (during valve closing of the valve portion 10, until the valve portion 10 has been seated on the valve seat 6, and during valve opening of the valve portion 10, until the flange 15 contacts the retaining ring 16 by collision), and particularly during the valve closing, the occurrence of water hammer can be prevented because the valve portion 10 gradually closes the inlet 4.

During the valve opening, impact when the flange 15 contacts the retaining ring 16 by collision can be relieved, which allows preventing the occurrence of impact noise due to the colliding contact and improving the retaining ring 16 and the piston 3 in durability.

Also, as with the second embodiment, in the proportional pressure reducing valve 1 where the cylindrical cover 19 is made transparent, because the interior of the hollow chamber 18 can be visually checked from the exterior of the valve box 2 through the cylindrical cover 19, even if there is by some chance a water leakage into the hollow chamber 18 through the airtight chamber 17 from a flow path in the valve box 2, the status thereof can be checked.

Then, the sealing plug 29 is opened when a water leakage into the hollow chamber 18 is confirmed, the water in the hollow chamber 18 is discharged to check the status as to if the water leakage is temporary and the like, which can then be used for the subsequent processing, operation, and the like.

Similarly, in the third embodiment, as a result of the transparent tube 30 being in communication with the hollow chamber 18, even if there is by some chance a water leakage into the hollow chamber 18 through the airtight chamber 17 from a flow path in the valve box 2, the status thereof can be checked from the exterior of the transparent tube 30.

Then, when a water leakage into the hollow chamber 18 is confirmed, by opening the stop cock 31 by a turning operation of the handle 31a, the water in the hollow chamber 18 is discharged to check the status as to if the water leakage is temporary and the like, which can then be used for the subsequent processing, operation, and the like.

### DESCRIPTION OF SYMBOLS

2 Valve box

2a (Valve box) sidewall

2b Opening portion

3 Piston

4 Inlet

5 Outlet

7 Lid body

8 Reduced diameter portion

10 Valve portion

11 Hollow portion

12 Water-flow port

15 Flange

17 Airtight chamber

19 Cylindrical cover

23 Diaphragm (helical groove)

24 Annular flow path

25 Annular flow path

29 Sealing plug

30 Transparent pipe

31 (Ball) stop cock

1. A proportional pressure reducing valve for waterworks constructed by providing a cylindrical valve box having an inlet opened in a front end surface thereof and an outlet set to be larger in diameter than the inlet and opened in a rear end surface thereof, forming a reduced diameter portion in an annular projection shape so as to bulge out on an inner wall between the inlet and the outlet of the valve box, inserting through the reduced diameter portion a piston in an airtight state and freely slidably, said piston being provided at its distal end with a valve portion that opens and closes the inlet and provided with a hollow portion opening at a base end side thereof to the outlet and having a plurality of water-flow ports in communication with the hollow portion opened in a distal end-side peripheral surface thereof located at all times further to the front than the reduced diameter portion, and providing a flange that slides in an airtight state a valve box inner wall that is further to the rear than the reduced diameter portion around the base end of the piston, wherein an airtight chamber provided between the flange and the reduced diameter portion is in communication with a hollow chamber defined by airtightly blocking a recess portion for which the periphery of a valve box outer wall is formed to cave in by a cylindrical cover externally fitted to the valve box.

2. The proportional pressure reducing valve for waterworks according to claim 1, wherein the airtight chamber and the hollow chamber are in communication with each other via a diaphragm.

3. The proportional pressure reducing valve for waterworks according to claim 2, wherein an annular flow path in communication with the airtight chamber and an annular flow path in communication with the hollow chamber are provided concentrically with the valve box and in a separated manner at the front and rear inside a valve box sidewall, and both annular flow paths are brought into communication with each other by a diaphragm formed by a helical groove provided inside the valve box sidewall so as to circle around a valve box axial center.

4. The proportional pressure reducing valve for waterworks according to claim 1, wherein the cylindrical cover is made transparent, an opening portion in external communication with the hollow chamber is provided in an appropriate part of the cylindrical cover, and the opening portion is airtightly blocked by a sealing plug.

5. The proportional pressure reducing valve for waterworks according to claim 1, wherein a stop cock is coupled to the cylindrical cover via a transparent pipe that is in communication with the hollow chamber.

6. The proportional pressure reducing valve for waterworks according to claim 1, wherein a large number of replaceable lid bodies are freely removably provided in an opening portion provided in the front end surface of the valve box, and inlets having different bores are formed in each of the lid bodies.
